(19) United States
(12) Patent Application Publication
(10) Pub. No.: US 2023/0167138 A1
(43) Pub. Date: Jun. 1, 2023

(54) Heteroatom-Containing Silane Compound

(71) Applicant: Henkel AG & Co. KGaA, Duesseldorf (DE)

(72) Inventors: Ligang Zhao, Duesseldorf (DE); Sebastien Lanau, Duesseldorf (DE); Andrea Gutacker, Langenfeld (DE); Johann Klein, Duesseldorf (DE); Ralf Dunekake, Duesseldorf (DE); Markus Bonigut, Hilden (DE); Theresia Kohler, Hasselt (BE); Esteban Mejia, Rostock (DE); Niklas Schafhausen, Rostock (DE)

(21) Appl. No.: 18/161,380

(22) Filed: Jan. 30, 2023

Related U.S. Application Data
(63) Continuation of application No. PCT/EP2021/072590, filed on Aug. 13, 2021.

(30) Foreign Application Priority Data
Aug. 19, 2020 (EP) 20191681.4

(51) Int. Cl. C07F 7/08

(52) U.S. Cl. CPC C07F 7/0814

(57) ABSTRACT

The invention relates to silane compounds of the general formula (I) as defined herein containing at least one heteroatom bridged to a silicon atom via a sp²-hybridized quaternary carbon atom, a process for preparing the silane compounds, and the use of the silane compounds as end-capping agent, crosslinker, and/or adhesion promoter in curable compositions.

The invention relates to silane compounds having at least one hydrolysable group and at least one heteroatom bridged to a silicon atom via a sp²-hybridized quaternary carbon atom, a process for preparing the silane compounds, and the use of the silane compounds as end-capping agent, crosslinker, and/or adhesion promoter in curable compositions.

EP 421129 A1 and EP 1414909 A1 demonstrated that polymers terminated with silyl groups having alkoxy groups and an electronegative, free electron-pair-containing heteroatom bridged to a silicon through a methylene group lead to faster curing, even at room temperature. These types of reagents are known in the art as alpha-silanes since the heteroatom is bound to a carbon atom in the position alpha to the silicon atom.

The use of alpha-silanes as cross-linking reagents in RTV formulations is advantageous since the amount of the vulcanization catalyst can be decreased thanks to the high reactivity of alpha-silanes. In some cases, the addition of a catalyst is not needed. Despite this advantage, the high reactivity of common methylene-bridged alpha-silanes represents in many applications an important drawback. For example, in some cases the use of methylene-bridged alpha-silanes lead to great difficulties regarding the short time of processability.

It is therefore an object of the present invention to provide silane compounds which overcome the disadvantages of the prior art.

The present invention provides silane compounds having at least one hydrolysable group and at least one heteroatom bridged to a silicon atom via a sp²-hybridized quaternary carbon atom, and the synthesis of said compounds with high yield. These silanes can be used as end-capping agent, crosslinkers and/or adhesion promoters in curable compositions.

In accordance with the first aspect of the invention there is provided a silane compound of the general formula (I) containing at least one heteroatom bridged to a silicon atom via a sp²-hybridized quaternary carbon atom:

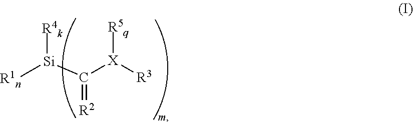

wherein

each R¹ is independently selected from a hydrolysable group, preferably selected from the group consisting of alkoxy, carboxy, oxime, amino, amido, lactato, alkenoxy, and acetoxy groups,

each R⁴ is independently selected from hydrogen or a linear or branched, substituted or unsubstituted hydrocarbon group having 1 to 20 carbon atoms, preferably selected from C₁ to C₂₀ alkyl, C₂ to C₂₀ alkenyl, C₅ to C₂₀ aryl, C₇ to C₂₀ alkaryl, or C₇ to C₂₀ aralkyl groups, which may contain at least one heteroatom, preferably selected from O, N, S, P, Si, Cl, Br, I or F;

X is a divalent or polyvalent heteroatom, preferably selected from O, S, N or P;

each R⁵ is independently selected from oxygen, hydrogen, or a linear or branched, substituted or unsubstituted hydrocarbon group having 1 to 20 carbon atoms, preferably selected from C₁ to C₂₀ alkyl, C₄ to C₈ cycloalkyl or C₆ to C₂₀ aryl groups, which may contain by at least one heteroatom, preferably selected from O, N, S, P, Si, Cl, Br, I or F;

R² and R³ are same or different and, independently from one another, selected from hydrogen or a linear or branched, substituted or unsubstituted hydrocarbon group having 1 to 20 carbon atoms, preferably C₁ to C₂₀ alkyl, C₂ to C₂₀ alkenyl, C₆ to C₂₀ aryl, C₇ to C₂₀ alkaryl or C₇ to C₂₀ aralkyl groups, which may contain at least one heteroatom, preferably selected from O, N, S, P, Si, Cl, Br, I or F, or R² and R³ may form a cyclic structure, preferably a substituted or unsubstituted 5- to 10-membered cyclic hydrocarbon structure containing the heteroatom X as part of the ring;
n is 1, 2 or 3, m is 1 or 2, k is 0 or 1, wherein the sum of n, m, and k is 4; and
q is an integer selected from 0 to 3.

The silane of the general formula (I) preferably is a heterocycle-containing silane of the general formula (I-A)

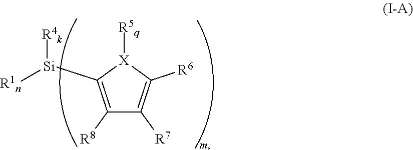

wherein
R¹, R⁴, R⁵, X, n, m, k, and q are as defined above;
R⁶, R⁷ and R⁸ are same or different, independently from one another, selected from hydrogen, a hydroxy group, or a linear or branched, substituted or unsubstituted hydrocarbon group having 1 to 20 carbon atoms, preferably selected from C₁ to C₂₀ alkyl, C₄ to C₈ cycloalkyl or C₆ to C₂₀ aryl groups, which may contain at least one heteroatom, preferably selected from O, N, S or Si.

As used herein, the singular forms “a”, “an” and “the” include plural referents unless the context clearly dictates otherwise.

The terms “comprising” and “comprises” as used herein are synonymous with “including”, “includes”, “containing” or “contains”, and are inclusive or open-ended and do not exclude additional, non-recited members, elements or method steps.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

The words “preferred” and “preferably” are used frequently herein to refer to embodiments of the disclosure that may afford particular benefits, under certain circumstances. However, the recitation of one or more preferable or preferred embodiments does not imply that other embodiments are not useful and is not intended to exclude those other embodiments from the scope of the disclosure.

As used herein, room temperature is 23° C. plus or minus 2° C.

The molecular weights given in the present text refer to number average molecular weights (Mn), unless otherwise stipulated. All molecular weight data refer to values obtained by gel permeation chromatography (GPC) carried out at 40° C. Tetrahydrofuran (THF) was used as an eluent. The sample was passed through three PSS SDV gel columns with molecular weight ranges of 102, 103 and 104 g·mol⁻¹ with a flow rate of 0.9 ml·min⁻¹. The calibration of the device was carried out using polystyrene standards.

As used herein, “polydispersity” refers to a measure of the distribution of molecular mass in a given polymer sample. The polydispersity is calculated by dividing the weight average molecular weight (Mw) by the number average molecular weight (Mn).

As used herein, “C₁ to C₂₀ alkyl” group refers to a monovalent group that contains 1 to 20 carbons atoms, that is a radical of an alkane and includes linear and branched organic groups. Examples of alkyl groups include, but are not limited to: methyl; ethyl; propyl; isopropyl; n-butyl; isobutyl; sec-butyl; tert-butyl; n-pentyl; n-hexyl; n-heptyl; and 2-ethylhexyl. In the present invention, such alkyl groups may be unsubstituted or may be substituted with one or more substituents such as halo, nitro, cyano, amido, amino, sulfonyl, sulfinyl, sulfanyl, sulfoxy, urea, thiourea, sulfamoyl, sulfamide and hydroxy. The halogenated derivatives of the exemplary hydrocarbon radicals listed above might, in particular, be mentioned as examples of suitable substituted alkyl groups. In general, however, a preference for unsubstituted alkyl groups containing from 1 to 12 carbon atoms (C₁-C₁₂ alkyl)—for example unsubstituted alkyl groups containing from 1 to 4 carbon atoms (C₁-C₄ alkyl)—should be noted.

As used herein, the term “C₂ to C₂₀ alkenyl” group refers to an aliphatic hydrocarbon group which contains 2 to 20 carbon atoms and at least one carbon-carbon double bond, e.g., ethenyl, propenyl, butenyl, or pentenyl and structural isomers thereof such as 1- or 2-propenyl, 1-, 2-, or 3-butenyl, etc. Alkenyl groups can be linear or branched and substituted or unsubstituted. If they are substituted, the substituents are as defined above for alkyl.

As used herein, the term “C₅ to C₂₀ aryl” group used alone or as part of a larger moiety—as in “aralkyl group”—refers to optionally substituted, monocyclic, bicyclic and tricyclic ring systems in which the monocyclic ring system is aromatic or at least one of the rings in a bicyclic or tricyclic ring system is aromatic. The bicyclic and tricyclic ring systems include benzofused 2-3 membered carbocyclic rings. Exemplary aryl groups include: phenyl; indenyl; naphthalenyl, tetrahydronaphthyl, tetrahydroindenyl; tetrahydroanthracenyl; pyridinyl; and anthracenyl. And a preference for phenyl groups may be noted.

As used herein, an “aralkyl” group refers to an alkyl group that is substituted with an aryl group. An example of an aralkyl group is benzyl.

Where mentioned, the expression “contain(s)/containing at least one heteroatom” means that the residue comprises at least one atom that differs from carbon atom and hydrogen. Preferably the term “heteroatom” refers to nitrogen, oxygen, silicon, sulfur, phosphorus, halogens such as Cl, Br, F. Sulfur (S), oxygen (O) and nitrogen (N) may be mentioned as typical heteroatoms in the context of the present invention.

As used herein, the “heterocyclic” compound refers to a saturated or unsaturated, monocyclic, bicyclic, polycyclic or fused compound containing at least one heteroatom, preferably O, S, N, and/or P, in the ring structure.

As used herein, the term “halogen” refers to fluorine, chlorine, bromine or iodine.

The silane compound of the general formula (I) or (I-A) has at least one, preferably at least two hydrolysable group R¹. In preferred embodiments, each R¹ is independently selected from the group consisting of alkoxy, carboxy, oxime, amino, amido, lactato, alkenoxy, and acetoxy groups. More preferably, each R¹ is independently selected from alkoxy groups, in particular is a methoxy or ethoxy group, most preferably is a methoxy group.

In preferred embodiments, each R⁴ is independently selected from hydrogen, or C₁ to C₂₀ alkyl, C₂ to C₂₀ alkenyl, C₅ to C₂₀ aryl, C₇ to C₂₀ alkaryl, or C₇ to C₂₀ aralkyl groups which may contain at least one heteroatom, preferably selected from O, N, S, P, Si, Cl, Br, I or F.

In more preferred embodiments, R⁴ is selected from hydrogen, or C₁ to C₁₂ alkyl, C₂ to C₁₂ alkenyl, C₅ to C₁₂ aryl, C₇ to C₁₃ alkaryl, or C₇ to C₁₃ aralkyl groups which may contain at least one heteroatom, more preferably selected from hydrogen, or C₁ to C₁₂ alkyl, C₂ to C₁₂ alkenyl, or C₅ to C₁₂ aryl groups which may contain at least one heteroatom, preferably selected from O, N, S, P, Si, Cl, Br, I or F.

In certain embodiments, R⁴ is selected from hydrogen, or C₂ to C₁₂ alkyl, C₂ to C₁₂ alkenyl, or C₅ to C₁₂ aryl groups which may contain at least one heteroatom, preferably selected from C₂ to C₁₂ alkenyl or C₅ to C₁₂ aryl groups which may contain at least one heteroatom, more preferably selected from ethyl, n-propyl, isopropyl, trifluoropropyl, aminopropyl, n-butyl, sec-butyl, tert-butyl, vinyl, phenyl, or pyridinyl group.

In certain embodiments, R⁴ can contain vinyl, amino, acrylate or hydroxy functionalities.

In certain embodiments, R⁴ can be selected from hydrogen, ethyl, phenyl, tolyl, benzoyl, vinyl, pyridinyl or aminoalkyl, such as aminopropyl. More preferably, R⁴ can be selected from phenyl, vinyl, or aminopropyl.

In preferred embodiments, X is selected from O, S, N or P, more preferably O or S, most preferably X is S.

In preferred embodiments, each R⁵ is independently selected from oxygen, hydrogen, or linear or branched, substituted or unsubstituted C₁ to C₂₀ alkyl, C₄ to C₈ cycloalkyl, or C₆ to C₂₀ aryl groups which may contain at least one heteroatom, preferably selected from O, N, S, P, Si, Cl, Br, I or F.

In preferred embodiments, R² and R³ are independently selected from hydrogen or a linear or branched, substituted or unsubstituted C₁ to C₂₀ alkyl, C₂ to C₂₀ alkenyl, C₆ to C₂₀ aryl, C₇ to C₂₀ alkaryl or C₇ to C₂₀ aralkyl groups which may contain at least one heteroatom, preferably selected from O, N, S, P, Si, Cl, Br, I or F. In other preferred embodiments, R² and R³ may form a cyclic structure, preferably a substituted or unsubstituted 5- to 10-membered cyclic hydrocarbon structure containing the heteroatom X as part of the ring, wherein X is preferably selected from O, S, N or P, more preferably O or S, most preferably is S.

In the general formula (I) or (I-A), n is 1, 2 or 3, preferably 2 or 3, m is 1 or 2, preferably 1, k is 0 or 1, wherein the sum of n, m, and k is 4. Preferably, m is 1 and n+k=3.

In the general formula (I-A), R⁶, R⁷ and R⁸ are same or different, independently from one another, selected from hydrogen, a hydroxy group, or a linear or branched, substituted or unsubstituted hydrocarbon group having 1 to 20 carbon atoms, preferably selected from C₁ to C₂₀ alkyl, C₄ to C₈ cycloalkyl or C₆ to C₂₀ aryl groups which may contain at least one heteroatom, preferably selected from O, N, S or Si. In important embodiments, R⁶, R⁷ and R⁸ are hydrogen.

The invention also provides a process for preparing a silane compound of the general formula (I) as defined herein, comprising the steps of:
a) contacting at least one metal with an organic solvent, wherein the metal is selected from the group consisting of Mg, Na, Li, Ca, Ba, Cd, and Zn, or mixtures or alloys thereof,
b) adding at least one silane of the general formula (II) to the organic solvent

Si(R¹)ₙ₊₁(R⁴)k (II),
wherein R¹ and R⁴, n, and k are as defined above, and
c) adding at least one halogenated compound of the general formula (III) to the reaction medium obtained in the step b)

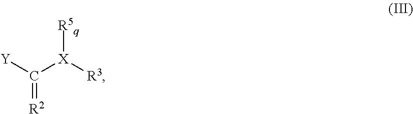

wherein R², R³, and R⁵, and q are as defined above; and
Y is a halogen atom.

In preferred embodiments, the halogenated compound having the general formula (III-A) is used in the step c) to obtain the silane of the general formula (I-A) as defined herein

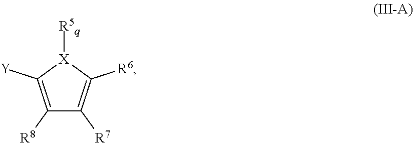

wherein R⁵ to R⁸, X and q are as defined above; and
Y is a halogen atom.

In the general formula (III) or (III-A), Y is preferably selected from Cl, Br, or I, more preferably Br.

The metal in step a) is selected from the group consisting of Mg, Na, Li, Ca, Ba, Cd, and Zn, or mixtures or alloys thereof. In preferred embodiments, the metal is Mg.

According to the present invention, the addition of the at least one halogenated compound of the general formula (III) or (III-A) (step c)) is conducted after the steps a) and b). This results in the in situ generation of an organometallic species which directly reacts with the halogenated organosilane to the desired product.

In preferred embodiments, the at least one halogenated compound of the general formula (III) or (III-A) is added in step c) while maintaining the temperature at a temperature lower than or equal to the boiling point of the organic solvent, more preferably at a temperature lower than the boiling point of the organic solvent. The halogenated compound of the general formula (III) or (III-A) can be added dropwise. A reduction in reaction temperature has been found to influence the yield. The reduced temperature suppresses initial side reactions, boosting the overall yield.

In preferred embodiments, the organic solvent is selected from cyclic ethers, or dialkyl ethers, or aryl ethers, preferably dioxane, tetrahydrofuran, 2-methyl-tetrahydrofuran, diethyl ether or cyclopentyl methyl ether, most preferably is tetrahydrofuran.

In particularly preferred embodiments, the organic solvent is tetrahydrofuran and the halogenated compound of the general formula (III) or (III-A) is added in step c) while maintaining the temperature at a temperature between 40° C. and 66° C., preferably between 40° C. and 60° C., more preferably between 40° C. and 50° C.

In preferred embodiments, the process according to the invention further comprises the step d): removing the organic solvent after the reaction in the step c), preferably by distillation under inert conditions and under reduced pressure and/or at increased temperature, and then adding a second organic solvent which is different from the removed solvent (hereinafter, also referred to as “first organic solvent”). The remaining halogenated compounds can be removed during the removal alongside the first organic solvent. Switching solvents during the procedure ensures substantially full precipitation of the obtained crude product, that contains desired product and starting silane material and only traces of remaining solvent.

In preferred embodiments, the second organic solvent, which is different from the first organic solvent, is selected from C₄₋₂₀ hydrocarbons with a dielectric constant (at 20° C.) lower than 3, preferably selected from alkanes or arenes, more preferably selected from n-pentane, n-hexane, n-heptane, cyclohexane, benzene, toluene or xylene, most preferably is an n-hexane.

In preferred embodiments, the molar ratio of the silane of the general formula (II) added in the step b) and the halogenated compound of the general formula (III) or (III-A) added in the step c) is from 1:5 to 5:1, preferably from 1:1 to 2:1.

In preferred embodiments, the silane compound of the general formula (I) as defined herein is obtainable by the above-described process.

In a further aspect, the invention relates to the use of the silane compound of the general formula (I) or (I-A) as end-capping agent, crosslinker, and/or adhesion promoter in curable compositions, preferably in moisture curable compositions.

The following examples are used to explain the invention; however, the invention is not limited thereto.

### EXAMPLES

### Preparation of the Silane Compound According to the Invention

### Examples 1 to 4

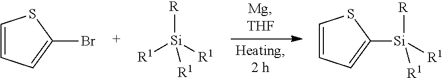

A three-neck round-bottom flask equipped with cooling condenser, dropping funnel, magnetic stir bar and a stopper is charged with magnesium chips (150 mmol, 1.5 eq, 3.6465 g) and flame-dried under reduced pressure. A crystal of iodine is added and sublimed by heating, etching the surface of the magnesium. Tetrahydrofuran (150 ml), followed by a silane of the general formula (II), wherein R¹ and R⁴ are as defined in Table 1, is added to the flask (150 mmol, 1.5 eq). The stopper is swapped for a thermometer. To the dropping funnel 2-bromothiophene (100 mmol, 1 eq) is added. While stirring, 10 vol % 2-bromothiophene is added to the flask in one portion. An increase in temperature is observed. Dropping is continued while maintaining a temperature between 40° C. and 50° C. After the addition heating to 60° C. is turned on for 2 h. The tetrahydrofuran is distilled off, leaving a wet grey solid. Hexane (150 ml) is added to the flask and the solid is suspended, turning the color from grey to white. The solids are filtered, and hexane is distilled off yielding a crude product (yield provided in Table 1). Clean product is obtained by the means of vacuum distillation at 1.0×10⁻³ mbar. The obtained silane compound has the above-shown general formula, wherein R¹ and R are as defined in Table 1.

TABLE 1
Yield of silane compounds synthesis

| | | | Crude | |
|---|---|---|---|---|
| | | | Yield | Distillation temperature |
| Compound | R | R¹ | [%] | at 1.0 × 10⁻³ mbar [° C.] |
| Ex. 1 | methoxy | methoxy | 51 | 85 |
| Ex. 2 | methyl | methoxy | 63 | 92 |
| Ex. 3 | phenyl | methoxy | 56 | 138 |
| Ex. 4 | vinyl | methoxy | 58 | 112 |

### Example 5

A silane compound was prepared according to the process for the preparation of Example 2 except that 2-bromothiphene was first added to the tetrahydrofuran and then the methyltrimethoxysilane was added thereto. The yield of synthesized silane compound according to Example 5 was 37%.

### Examples 6 and 7

Silane compounds were prepared according to the process for the preparation of Example 2 except that 2-bromothiphene was added while maintaining a temperature as shown in Table 2. The yields of synthesized silane compounds according to Examples 6 and 7 are provided in Table 2.

TABLE 2

| | Reaction temperature | |
|---|---|---|
| Compound | [° C.] in step c) | Crude yield [%] |
| Ex. 2 | 40-50 | 63 |
| Ex. 6 | 50-60 | 60 |
| Ex. 7 | 60-66 | 55 |

1. A silane compound of the general formula (I) containing at least one heteroatom bridged to a silicon atom via a sp²-hybridized quaternary carbon atom 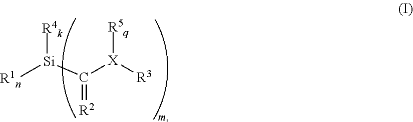
wherein
each R¹ is independently selected from a hydrolysable group,
each R⁴ is independently selected from hydrogen or a linear or branched, substituted or unsubstituted hydrocarbon group having 1 to 20 carbon atoms which may contain at least one heteroatom;
X is a divalent or polyvalent heteroatom;
each R⁵ is independently selected from oxygen, hydrogen, or a linear or branched, substituted or unsubstituted hydrocarbon group having 1 to 20 carbon atoms which may contain at least one heteroatom;
R² and R³ are same or different and, independently from one another, selected from hydrogen or a linear or branched, substituted or unsubstituted hydrocarbon group having 1 to 20 carbon atoms which may contain at least one heteroatom, or R² and R³ may form a cyclic structure;
n is 1, 2 or 3, m is 1 or 2, k is 0 or 1, wherein the sum of n, m, and k is 4; and
q is an integer selected from 0 to 3.

2. The silane compound according to claim 1, having the general formula (I-A) 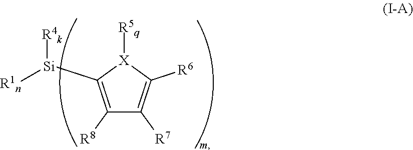
wherein
R¹, R⁴, R⁵, X, n, m, k, and q are as defined in claim 1;
R⁶, R⁷ and Ware same or different, independently from one another, selected from hydrogen, a hydroxy group, or a linear or branched, substituted or unsubstituted hydrocarbon group having 1 to 20 carbon atoms which may contain at least one heteroatom.

3. The silane compound according to claim 2, wherein R⁶, R⁷ and Ware the same or different and independently from one another are selected from hydrogen, C₁ to C₂₀ alkyl, C₄ to C₈ cycloalkyl or C₆ to C₂₀ aryl groups which may contain at least one heteroatom.

4. The silane compound according to claim 1, wherein
i) each R¹ is independently selected from the group consisting of alkoxy, carboxy, oxime, amino, amido, lactato, alkenoxy, and acetoxy groups; and/or
ii) each R⁴ is independently selected from hydrogen, or C₁ to C₂₀ alkyl, C₂ to C₂₀ alkenyl, C₅ to C₂₀ aryl, C₇ to C₂₀ alkaryl, or C₇ to C₂₀ aralkyl groups which may contain at least one heteroatom selected from O, N, S, P, Si, Cl, Br, I or F.

5. The silane compound according to claim 1, wherein each R⁴ is independently selected from hydrogen, C₂ to C₁₂ alkyl, C₂ to C₁₂ alkenyl, or C₅ to C₁₂ aryl group, any of which may contain at least one heteroatom.

6. The silane compound according to claim 1, wherein each R⁴ is independently selected from hydrogen, ethyl, n-propyl, isopropyl, trifluoropropyl, aminopropyl, n-butyl, sec-butyl, tert-butyl, vinyl, phenyl, or pyridinyl group.

7. The silane compound according to claim 1, wherein X is selected from O, S, N or P.

8. The silane compound according to claim 1, wherein n is 2 or 3 and/or m is 1.

9. A curable composition comprising the silane compound according to claim 1.

10. An end-capping agent, crosslinker and/or adhesion promoter comprising the silane compound according to claim 1.

11. A process for preparing a silane compound of the general formula (I) as defined in claim 1, comprising the steps of:
a) contacting at least one metal with an organic solvent, wherein the metal is selected from the group consisting of Mg, Na, Li, Ca, Ba, Cd, and Zn or mixtures or alloys thereof,
b) adding at least one silane of the general formula (II) to the organic solvent
si(R¹)ₙ₊₁(R⁴)k (II),
wherein R¹ and R⁴, n, and k are as defined above, and
c) adding at least one halogenated compound of the general formula (III) to the reaction medium obtained in the step b) 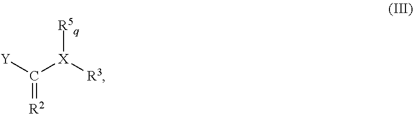
wherein R², R³, and R⁵, and q are as defined above; and
Y is a halogen atom.

12. The process according to claim 11, wherein the halogenated compound has the general formula (III-A) 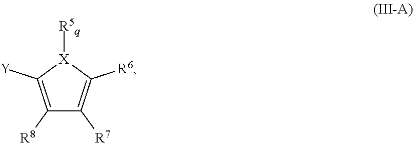
wherein
wherein R⁵ to R⁸, X, and q are as defined above; and
Y is a halogen atom.

13. The process according to claim 11, wherein the halogenated compound of the general formula (III) or (III-A) is added in step c) while maintaining the temperature at a temperature lower than or equal to the boiling point of the organic solvent.

14. The process according to claim 11, wherein the organic solvent is selected from cyclic ether, dialkyl ether, or aryl ether.

15. The process according to claim 11, wherein the organic solvent is selected from dioxane, tetrahydrofuran, 2-methyl-tetrahydrofuran, diethyl ether or cyclopentyl methyl ether.

16. The process according to claim 11, wherein the organic solvent is tetrahydrofuran and the halogenated compound of the general formula (III) or (III-A) is added in step c) while maintaining the temperature at a temperature between 40° C. and 66° C.

17. The process according to claim 11, further comprising step d): removing the organic solvent after the reaction in the step c) and adding a second organic solvent which is different from the removed solvent.

18. The process according to claim 17, wherein the second organic solvent is selected from C₄₋₂₀ hydrocarbons with a dielectric constant at 20° C. lower than 3.

19. The process according to claim 17, wherein the second organic solvent is selected from n-pentane, n-hexane, n-heptane, cyclohexane, benzene, toluene or xylene.

20. A moisture curable composition comprising the silane compound prepared by the process of claim 11.
